(19) United States
(12) Patent Application Publication
(10) Pub. No.: US 2003/0086367 A1
(43) Pub. Date: May 8, 2003

(54) METHOD FOR MONITORING SPARE CAPACITY OF A DRA NETWORK

(76) Inventors: LEE D. BENGSTON, MURPHY, TX (US); MARK W. SEES, ALLEN, TX (US); CLINT A. WAGNER, ALLEN, TX (US)

Correspondence Address: WORLDCOM, INC., TECHNOLOGY LAW DEPARTMENT, 1133 19TH STREET NW, WASHINGTON, DC, 20036, US

(21) Appl. No.: 09/365,081

(22) Filed: Jul. 30, 1999

Related U.S. Application Data
(60) Provisional application No. 60/099,582, filed on Sep. 8, 1998.

(51) Int. Cl. H04L 12/26

(52) U.S. Cl. 370/216

(57) ABSTRACT

To obtain a topology of the available spare links in a telecommunications network provisioned with a distributed restoration algorithm, messages containing the appropriate identifications of the nodes and the ports of the nodes to which spare links are connected are exchanged continuously along the spare links of the network. When a failure is detected, the origin node can retrieve the various messages, and from data contained therein, to construct a topology of the available spare links of the network which can then be used for finding an alternate route for rerouting the traffic disrupted by the failure.

This application claims the benefit of U.S. Provisional Application No. 60/099,582 filed on Sep. 8, 1998.

### CROSS REFERENCE TO RELATED APPLICATIONS

The instant invention relates to the following applications having Ser. Nos. 08/825,440 filed Mar. 28, 1997, 08/825,441 filed Mar. 28, 1997, 09/046,089 filed Mar. 23, 1998, Ser. No. 09/148,944 filed Sep. 8, 1998, entitled “Restricted Reuse of Intact Portions of Failed Paths”, and Ser. No. 09/149,591 filed Sep. 8, 1998, entitled “Signal Conversion for Fault Isolation”. The respective disclosures of those applications are incorporated by reference to the disclosure of the instant application.

The instant invention further relates to applications Ser. Nos. 08/483,579 filed Jun. 7, 1995, 08/736,800 filed Oct. 25, 1996 and 08/781,495 filed Jan. 13, 1997. The respective disclosures of those applications are likewise incorporated herein by reference.

This application is further related to the invention Ser. No. 09/148,942 filed Sep. 8, 1998, entitled “Quantification Of The Quality Of Spare Links In A Telecommunications Network”, the disclosure of which being incorporated by reference herein.

### FIELD OF THE INVENTION

This invention relates to a distributed restoration algorithm (DRA) network, and more particularly to a method of monitoring the topology of the spare links in the network for rerouting traffic in the event that the traffic is disrupted due to a failure in one of the working links of the network.

### BACKGROUND OF THE INVENTION

In a telecommunications network provisioned with a distributed restoration algorithm (DRA), the network is capable of restoring traffic that has been disrupted due to a fault or malfunction at a given location thereof In such DRA provisioned network, or portions thereof which are known as domains, the nodes, or digital cross-connect switches, of the network are each equipped with the DRA algorithm and the associated hardware that allow each node to seek out an alternate route to reroute traffic that has been disrupted due to a malfunction or failure at one of the links or nodes of the network. Each of the nodes is interconnected, by means of spans that include working and spare links, to at least one other node. Thus, ordinarily each node is connected to an adjacent node by at least one working link and one spare link. It is by means of these links that messages, in addition to traffic signals, are transmitted to and received by the nodes.

In a DRA network, when a failure occurs at one of the working links, the traffic is rerouted by means of the spare links. Thus, to operate effectively, it is required that the spare links of the DRA network be functional at all times, or at the very least, the network keeps track of which spare links are functional and which are not.

There is therefore a need for the instant invention DRA network to always have an up-to-date map of the functional spare links, i.e. the spare capacity, of the network, so that traffic that is disrupted due to a failure can be readily restored.

### SUMMARY OF THE PRESENT INVENTION

To provide an up-to-date map of the functional spare links of a network, a topology of the network connected by the functional spare links is made available to custodial nodes bracket on either end of a malfunctioned link as soon as the failure is detected. The custodial node that is designated as the sender or origin node then uses the topology of the spare links to quickly reroute the traffic through the functional spare links.

To ensure that the spare links are functional, prior to the failure, special messages, referred to in this invention as “keep alive messages”, are continuously exchanged on the spare links between adjacent nodes. Each of these keep alive messages has a number of fields that allow it to identify the port of the node from which it is transmitted, the identification of the node, the incoming IP address and the outgoing IP address of the node, as well as a special field that identifies the keep alive message as coming from a custodial node when there is a detected failure. These keep alive messages may be transmitted over C-bit channels.

So long as a spare link is operating properly, the keep alive messages that traverse therethrough will contain data that informs the network, possibly by way of the operation support system (OSS), of the various pairs of spare ports to which a spare link connects a pair of adjacent nodes. This information is collected by the network and constantly updated so that, at any moment, the network has a view of the entire topology of the network as to what spare links are available.

It is therefore an objective of the present invention to provide a method of mapping a topology of the spare capacity of a DRA network so that traffic may be routed through the functional spare links when a failure occurs at the network.

It is another objective of the present invention to provide a special message that is exchanged continuously between adjacent nodes before the occurrence of the failure in order to continually collect data relating to the available spare links of the network.

### BRIEF DESCRIPTION OF THE FIGURES

FIG. 1 is an illustration of a telecommunications network of the instant invention.

FIG. 2 is a block diagram illustrating two adjacent cross-connect switches and the physical interconnection therebetween.

FIG. 3 is an illustration of the structure of an exemplar keep alive message of the present invention.

FIG. 4 is a flow chart of the process for creating the topology mapping for the telecommunications network of FIG. 1.

### DETAILED DESCRIPTION OF THE PRESENT INVENTION

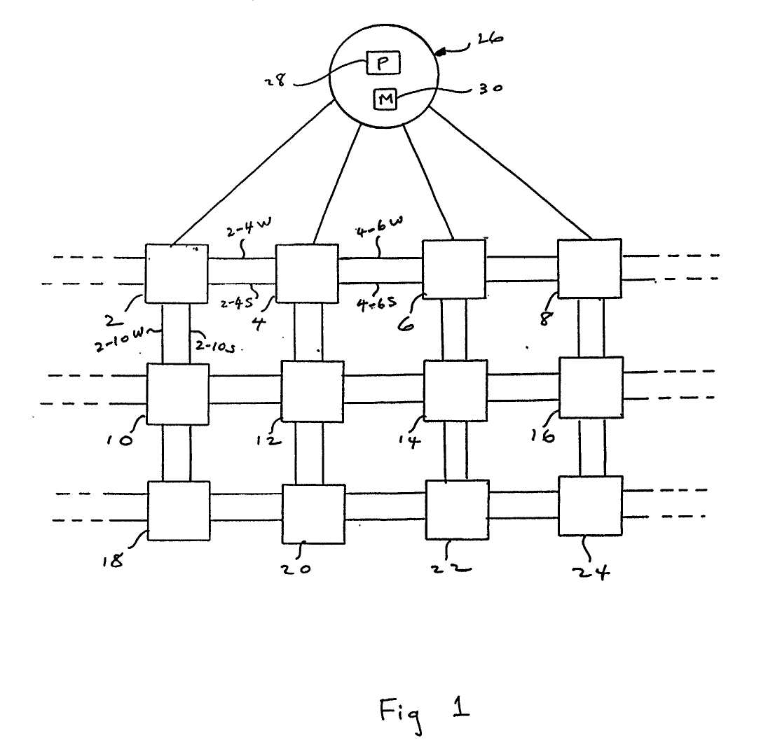

The exemplar telecommunications network of the instant invention, as shown in FIG. 1, comprises a number of nodes 2-24 each connected to adjacent nodes by at least one working link and one spare link. For example, node 2 is connected to node 4 by means of a working link 2-4W and a spare link 2-4S. Similarly, node 4 is connect to node 6 by a working link 4-6W and a spare link 4-6S. For the sake of simplicity, only the specific links connecting nodes 2-4, 4-6 and 2-10 are appropriately numbered in FIG. 1. But it should be noted that the working and spare links connecting adjacent nodes can be similarly designated.

For the telecommunications network of FIG. 1, it is assumed that all of the nodes of the network are provisioned with a distributed restoration algorithm (DRA), even though in practice one or more portions of the telecommunications network are provisioned for distributed restoration. In those instances, those portions of the network are referenced as dynamic transmission network restoration (DTNR) domains.

Also shown in FIG. 1 is an operation support system (OSS) 26. OSS 26 is where the network management monitors the overall operation of the network. In other words, it is at OSS 26 that an overall view, or map, of the layout of each node within the network is provided. OSS 26 has a central processor 28 and a memory 30 into which data retrieved from the various nodes are stored. Memory 30 may include both a working memory and a database store. An interface unit, not shown, is also provided in OSS 26 for interfacing with the various nodes. As shown in FIG. 1, for the sake of simplicity, only nodes 2, 4, 6, and 8 are shown to be connected to OSS 26. Given the interconnections between OSS 26 and the nodes of the network, activity within each of the nodes of the network is monitored by OSS 26.

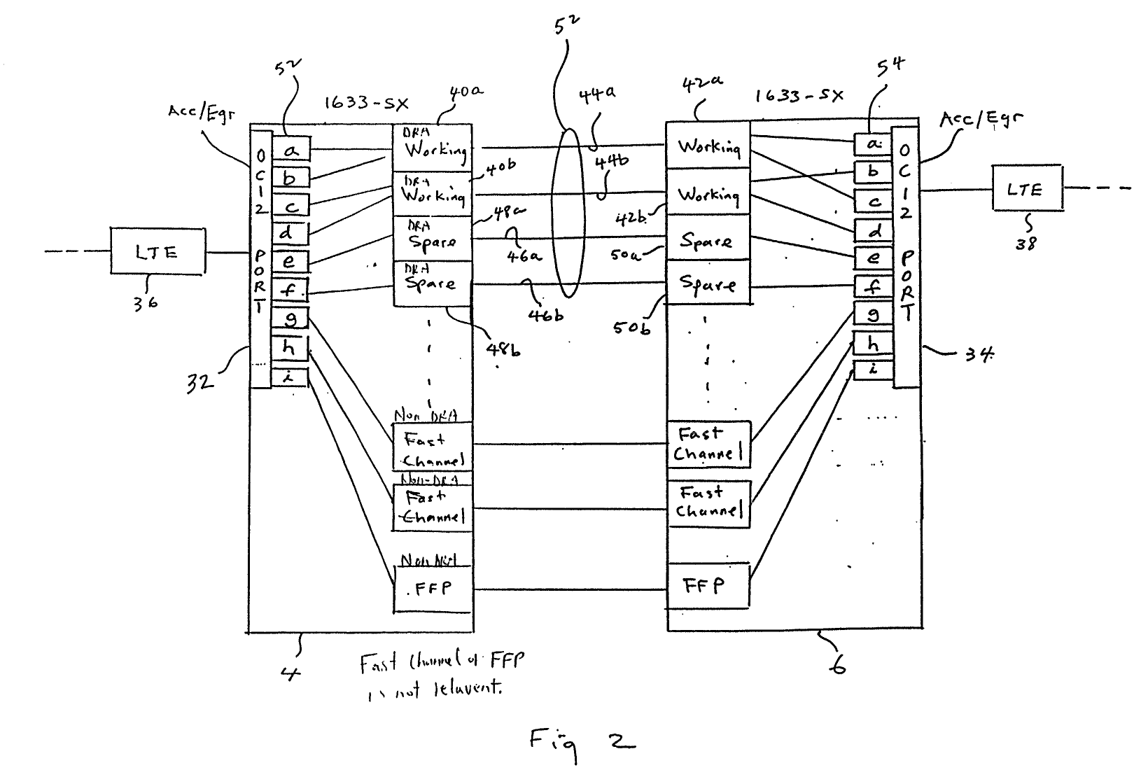

Each of the nodes 2-24 of the network comprises a cross-connect switch, such as the 1633-SX broadband cross-connect switch made by Alcatel USA. Two adjacently connected switches are shown in FIG. 2. The switches may represent any two adjacent switches located at adjacent nodes in the network, such as nodes 4 and 6 of FIG. 1. As shown, each of the switches has a number of access/egress ports 32 and 34 that are shown to be multiplexed to a line terminating equipment (LTE) 36 and 38, respectively. LTEs 36 and 38 are SONET equipment having a detector residing therein for detecting any failure of the links between the various digital cross-connect switches. Again, for the sake of simplicity, such LTE is not shown to be sandwiched between nodes 4 and 6, as detection circuits for interpreting whether a communication failure has occurred may also be incorporated within the respective working cards 40a and 40b of node 4 and 42a and 42b of node 6.

As shown in FIG. 2, each of the digital cross-connect switches has two working links 44a and 44b communicatively connecting node 4 and node 6 through working interface cards 40a and 40b along with 42a and 42b, respectively. Also shown connecting node 4 and node 6 are a pair of spare links 46a and 46b, which are connected to the spare link interface cards 48a and 48b along with 50a and 50b of node 4 and node 6, respectively. For the FIG. 2 embodiment, assume that each of the working links 44a and 44b and spare links 46a and 46b is a part of a logical span 52. Further note that even though only four links are shown to connect node 4 to node 6, in actuality, adjacent nodes may be connected by more or less links. Likewise, even though only four links are shown to be a part of span 52, in actuality, a span that connects two adjacent nodes may in fact have a greater number of links. For the instant discussion, assume that working links 44a and 44b correspond to the working link 4-6W of FIG. 1 while the spare links 46a and 46b of FIG. 2 correspond to the spare link 4-6S of FIG. 1. For the purpose of the instant invention, each of the links shown is presumed to be a conventional optical carrier OC-12 fiber or is a link embedded within a higher order (i.e., OC-48 or OC-192) fiber.

Focusing onto node 4 for the time being, note that each of the interfacing cards or boards, of that digital cross-connect switch, such as 40a, 40b, 48a and 48b, is connected to a number of STS-1 ports 52 for transmission to SONET LTE 36. Although not shown, an intelligence, such as a processor residing in each of the digital cross-connect switches, controls the routing and operation of the various interfacing boards and ports. Also not shown, but present in each of the digital cross-connect switches, is a database storage for storing a map that identifies the various sender nodes, chooser nodes, and addresses, which will be discussed later. The working boards 42a and 42b and the spare boards 50a and 50b are likewise connected to the access/egress ports 54 in node 6. Further shown in FIG. 2 are fast channel connections between adjacent nodes 4 and 6, as well as a dedicated cross-connection between those nodes by respective FHP interface boards.

For the instant invention, the access/egress ports, such as 32 and 34, send their respective port numbers through the matrix in each of the digital cross-connects to its adjacent nodes. Thus, for the exemplar interconnected adjacent nodes 4 and 6, ports 52a and 52b of node 4 are connected to ports 54a and 54c of node 6, respectively, by means of working link 44a. Similarly, ports 52e and 52f of node 4 are interconnected to ports 54e and 54f of node 6 by way of spare links 46a and 46b, respectively. Thus, if node 4 were to transmit a signal using spare link 46a to node 6, it will be transmitting such a message from its port 52e to spare card 48a and then onto spare link 46a, so that the message is received at spare card 50a of node 6 and routed to the receiving port 54e of node 6. Thus, as long as working links and spare links interconnecting a pair of adjacent nodes, such as for example nodes 4 and 6, are operational when a message is sent between those nodes, the information relating to the respective transmit and receiving ports can be collected by the OSS 26 (FIG. 1) so that a record can be collected of the various ports that interconnect any two adjacent nodes.

For the instant invention, the inventors have seized upon the idea that a topology or map of the available spare capacity of the network, in the form of the available spare links that interconnect the nodes, can be generated from stored data that is representative of the different port numbers of the various nodes to which spare links are connected. In other words, if a message transmitted by one node to its adjacent node is able to provide OSS 26 a number of parameters that include for example the ID of the transmit node, the respective IP (internal protocol) addresses of the transmit and receiving ports of the node and the port number from which the message is transmitted from the node, then the OSS can ascertain an overall picture of the spare capacity of the network from similar messages that are being exchanged between adjacent nodes on spare links connecting those adjacent nodes.

Simply put, if each of the digital cross-connect switches in the DRA provisioned network knows the port number and the node that it is connected to by its spare link, then that node knows how to reroute traffic if it detects a failure in one of its working links. And by collecting the information relating to each of the nodes of the network, the OSS 26 is able to obtain an overall view of all of the available spare links that interconnect the various nodes. As a consequence, when a failure occurs at a given working link, OSS 26 can send to the custodial nodes of the failed link a map of the spare capacity of the network. Thus, the custodial node can then use the map of the spare capacity of the network to begin the restoration process by finding an alternate route for the disrupted traffic.

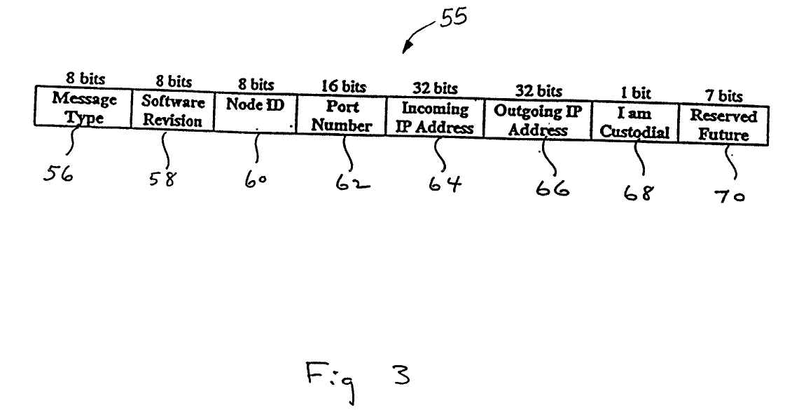

FIG. 3 shows a structure for one embodiment of a special message 55 that is to be used for continuously monitoring the available spare capacity of the network. The special message 55 is also referred to as a “keep alive” message. As shown, the keep alive message 55 has a number of fields. Field 56 is an 8 bit message field that can be configured to represent the keep alive message 55 so that each node in receipt of the message will recognize that this is a keep alive message for updating the availability status of spare links. OSS 26, on the other hand, upon receipt of the keep alive message 55, would group it with all the other keep alive messages received from the different nodes for mapping the spare capacity of the network.

Field 58 is an 8 bit field that contains the software revision number of the DRA being used in the network. Field 60 is an 8 bit field that contains the node identifier of the transmitting node. Field 62 is a 16 bit field that contains the port number of the transmitting node from which the keep alive message 55 is sent. Field 64 is a 32 bit field that contains the IP address of the DS3 port on the node that is used for half-duplex incoming messages. Field 66 is a 32 bit field that contains the IP address of the DS3 port of the node that is used for half-duplex outgoing messages. Field 68 is a 1 bit field that, when set, indicates to the receiving node that the message is sent from a custodial node for a failure. In other words, when there is a failure, the custodial node of the failed link will send out a keep alive message that informs nodes downstream thereof that the keep alive message is being sent from a custodial node since a failure has occurred, and a restoration process will proceed. Field 70 has 7 bits and is reserved for future usage.

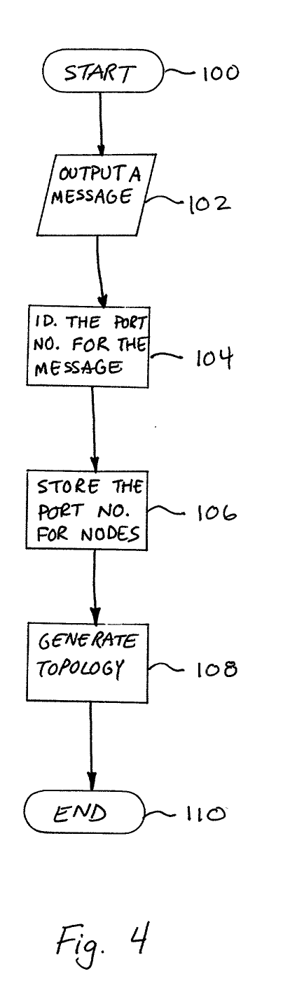

Referring now to FIG. 4, the mapping process begins at step 100. At step 102 a message, such as the keep alive message 55 of FIG. 3, is generated from each spare link and exchanged between adjacent nodes. At step 104 the location of the port of the node from where the message was generated is identified. At step 106 the identified locations, which contain updated information on the availability of spare links, are stored. At step 108, the mapping topology is generated using the stored identified locations, which is used for routing traffic around a problem link using the spare links.

In operation, before any failure is detected, keep alive messages, such as the keep alive message 55, are continuously exchanged on the spare links between adjacent nodes. By the exchange of these keep alive messages, the network is able to keep a tab of the various available and functional spare links and also identify the port number of each node from where each spare link outputs a keep alive message, as well as the port number of the adjacent node to which the spare link is connected and to which the keep alive message is received. By collecting the data that is contained in each of the keep alive messages, a record is kept of the various nodes, the port numbers, the incoming and outgoing IP addresses of the various spare links that are available in the network. From the collected data, a topology of the available spare capacity of the network can be generated by either the OSS 26 or each of the nodes, which can have the collected information downloaded thereto for storage. In any event, a map of the available spare links of the network is available, so that when a failure does occur, the custodial nodes of the failure could retrieve the up-to-date map of the spare capacity of the network, and based on that, be able to find the most efficient alternate route for rerouting the disrupted traffic.

Given that the instant invention relates to a distributed restoration process, it should be noted that an OSS is not necessary for storing the topology of the spare capacity of the network, as each of the digital cross-connect switches of the network knows what port number and the nodes that it is connected to by its spare links. Thus, when a failure occurs, each of the nodes will continue to send the keep alive message, as the origin node that is responsible for restoration can built the entire topology of the available spare links by retrieving the different keep alive messages from the various nodes. Putting it differently, an origin node, in attempting to determine the available spare links, only needs to take the sum of all of the keep alive messages since each node that has at least one spare link will send a keep alive message to the origin node. By retrieving the ID of the node and the port numbers of the node to which spare links are connected, the spare capacity of the network can be ascertained. As a consequence, the map of the spare link topology becomes available in a distributed matter to the origin node in the instant invention DRA provisioned network.

Inasmuch as the present invention is subject to many variations, modifications and changes in detail, it is intended that all matter described throughout this specification and shown in the accompanying drawings be interpreted as illustrative only and not in a limiting sense. Accordingly, it is intended that the present invention be limited only by the spirit and scope of the hereto appended claims.

What is claimed is:

1. A method of mapping a topology of a spare capacity of a distributed restoration algorithm (DRA) provisioned telecommunications network having a plurality of nodes interconnected with working and spare links, the method comprising:
outputting a message from each spare link of each of the nodes to the adjacent node to which the spare link is connected;
identifying the port number of the node from where the spare link outputs the message and the port number of the adjacent node connected to the spare link whereat the message is received;
storing as data the respective port numbers of the nodes that have connected thereto at least one spare link via which the message is either sent or received, the identifies of the nodes and the spare links interconnecting the nodes; and
generating from the stored data the topology of spare links interconnecting the nodes of the network.

2. The method of claim 1, further comprising:
storing the data in a central processing means; and
providing the generated topology of the spare links of the network to an origin node for beginning the restoration process if a failure occurs in the network.

3. The method of claim 2, further comprising:
continuously updating the status of the message arriving at each spare port of the nodes of the network; and
storing the updated status in a central processing means, wherein the central processing means uses the updated status to provide a real time topology of the spare capacity of the network.

4. The method of claim 1, wherein when a failure occurs in the network, further comprising the step of transmitting from a custodial nodes of the failed link a message, via a functional spare link, to downstream nodes thereof to inform downstream nodes that it is a custodial node.

5. The method of claim 1, further comprising:
selecting a custodial node of a failed link to be an origin node; and
the origin node utilizing the topology of the spare capacity of the network to find an alternate route for the disrupted traffic.

6. In a distributed restoration algorithm (DRA) provisioned telecommunications network having a plurality of nodes interconnected with working and spare links, a message being transmitted between adjacent nodes of the network that are connected by at least one spare link for mapping the topology of the spare capacity of the network, comprising:
a first field containing the identification number of the node that sent the message;
a second field containing the identification number of the port of the node whence the message is output; and
a third field having an identifier that is set to a specific value when the node is a custodial nodes that bracket a failed link, wherein the message is broadcast from one of the custodial nodes that bracket a failed link.

7. The message of claim 6, further comprising:
a fourth field for identifying the message to be a message that is continuously transmitted and exchanged along spare links between adjacent nodes of the network while a DRA process is not in progress.
